(19) United States
(12) Patent Application Publication
(10) Pub. No.: US 2021/0147590 A1
(43) Pub. Date: May 20, 2021

(54) PROCESS FOR THE PRODUCTION OF ISOBUTENE POLYMERS WITH IMPROVED TEMPERATURE CONTROL

(71) Applicant: ARLANXEO DEUTSCHLAND GMBH, Dormagen (DE)

(72) Inventors: Hanns-Ingolf PAUL, Leverkusen (DE); Rolf FELLER, Solingen (DE); John George Arnold LOVEGROVE, Sarnia (CA); Jörg KIRCHHOFF, Köln (DE); Paul WAGNER, Düsseldorf (DE); Ricarda LEIBERICH, Neu-Isenburg (DE); Joachim RITTER, Leverkusen (DE)

(21) Appl. No.: 16/629,634

(22) PCT Filed: Jul. 6, 2018
(86) PCT No.: PCT/EP2018/068392

§ 371 Date: Jan. 9, 2020

(30) Foreign Application Priority Data
Jul. 13, 2017 (EP) 17181176.3

(51) Int. Cl. C08F 210/12; C08F 2/06; C08F 4/14

(52) U.S. Cl. CPC C08F 210/12; C08F 4/14; C08F 2/06

(57) ABSTRACT

The invention relates to an efficient process for the preparation of isoolefin polymers such as polyisobutene or butyl rubber by polymerization of a liquid medium comprising the monomer(s) and ethane or carbon dioxide that is substantially dissolved therein.

### FIELD OF THE INVENTION

The invention relates to an efficient process for the preparation of isoolefin polymers such as polyisobutene or butyl rubber by polymerization of a liquid medium comprising the monomer(s) and ethane or carbon dioxide that is substantially dissolved therein.

### BACKGROUND

Polymers containing repeating units derived from isoolefins are industrially prepared by carbocationic polymerization processes. Of particular importance are polyisobutene and butyl rubber which is a copolymer of isobutylene and a smaller amount of a multiolefin such as isoprene.

The carbocationic polymerization of isoolefins and its copolymerization with multiolefins is mechanistically complex. The catalyst system is typically composed of two components: an initiator and a Lewis acid such as aluminum trichloride which is frequently employed in large scale commercial processes.

Examples of initiators include proton sources such as hydrogen halides, alcohols, phenols, carboxylic and sulfonic acids and water.

During the initiation step, the isoolefin reacts with the Lewis acid and the initiator to produce a carbenium ion which further reacts with a monomer forming a new carbenium ion in the so-called propagation step.

The type of monomers, the type of diluent or solvent and its polarity, the polymerization temperature as well as the specific combination of Lewis acid and initiator affects the chemistry of propagation and thus monomer incorporation into the growing polymer chain.

Industry has generally accepted widespread use of a slurry polymerization process to produce butyl rubber, polyisobutylene, etc. in methyl chloride as diluent. Typically, the polymerization process is carried out at low temperatures, generally lower than −90° C. Alkyl chlorides, in particular methyl chloride are employed for a variety of reasons, including that it dissolves the monomers and aluminum chloride catalyst but not the polymer product. Methyl chloride also has suitable freezing and boiling points to permit, respectively, low temperature polymerization and effective separation from the polymer and unreacted monomers. The slurry polymerization process in methyl chloride offers the advantage that a polymer concentration of up to 40 wt.-% and more in the reaction mixture can be achieved, as opposed to a polymer concentration of typically at technically feasible maximum 20 wt.-% in solution polymerizations depending on the targeted molecular weight. An acceptable relatively low viscosity of the polymerization solution has to be maintained enabling the heat of polymerization to be removed via heat exchange across the surface of the reaction device. Slurry and solution polymerization processes in methyl chloride or alkanes are used in the production of high molecular weight polyisobutylene and isobutylene-isoprene butyl rubber polymers.

Alternatively, aliphatic solvents like normal and iso pentanes and hexanes as well as mixtures are used for polymerization as for examples disclosed in WO2010/006983A and WO2011/089092A which have significant advantages in the downstream processing e.g. chemical modification of the polymer. The butyl rubber prepared during polymerization is dissolved in these aliphatic media and so these processes are normally referred to as a solution processes.

A common feature of both, slurry and solution processes is that due to the high reactivity of the initiators employed temperature control and the avoidance of so called “hot spots” due to inhomogenities of the polymerization medium is difficult but crucial to achieve a desired product quality and to avoid reactor fouling, i.e. the formation of deposits of polymers on the surfaces of the reactor. Such deposits, due to their insulating effect, reduce cooling efficiency and may cause a rapid rise of temperature within the reactor thereby increasing the rate of the exothermic polymerization and fast production of further heat which is again insufficiently removed. Finally, this may even lead to a thermal runaway.

Several attempts have been made in the past to support external cooling with the aim to maintain a desired (low) temperature within a reactor by adding a liquid or solid refrigerant to the polymerization medium that virtually does not react under polymerization conditions and allows to maintain a certain temperature level around its boiling or sublimation point. The evaporation of the refrigerant requires a defined enthalpy of vaporization and thus prevents an undesired rise of temperature above the boiling or sublimation point as long as refrigerant is present in the polymerization medium. The evaporated refrigerant is typically recycled and used again.

GB 543,308 discloses the use of solid carbon dioxide as refrigerant in the batch copolymerization of isobutene and butadiene at −78° C.

In U.S. Pat. Nos. 2,545,144, 4,691,072, 4,663,406, EP 025 530 A, EP 154 164 A, U.S. Pat. Nos. 4,400,493 and 4,391,959 the use of ethylene, ethane and propane as low boiling solvents (refrigerants) in the manufacture of polyisobutene is disclosed. Where ethylene is employed the polymerization temperature was reported to be −104° C.

It is further known from U.S. Pat. No. 5,763,544 to inject cryogenic liquids such as liquid nitrogen i.a. into reactors for bulk polymerizations, oxidations or hydrogenations.

However, handling and dosing of liquid gases, separation of complex mixtures of various alkanes or the presence of olefins either require high investments in suitable devices or purity grades of the refrigerants that limit their availability.

Therefore, there still remains a need for providing a versatile process for the preparation of high quality polyisobutene or butyl rubber with superior temperature control

### SUMMARY OF THE INVENTION

According to one aspect of the invention, there is now provided a process for the preparation of isoolefin polymers, the process comprising at least the steps of:
a) providing a reaction medium comprising an organic diluent and at least one monomer being an isoolefin and ethane or carbon dioxide that is substantially dissolved in the reaction medium, and;
b) polymerizing the at least one monomer within the reaction medium in the presence of an initiator system to form a product medium comprising the copolymer, the organic diluent and optionally residual monomers whereby the ethane or the carbon dioxide of the reaction medium is at least partially evaporated.

### DETAILED DESCRIPTION OF THE INVENTION

The invention also encompasses all combinations preferred embodiments, ranges parameters as disclosed hereinafter with either each other or with the broadest disclosed range or parameter.

### Isoolefins and Other Monomers

In step a) a reaction medium comprising an organic diluent and at least one monomer being an isoolefin and ethane or carbon dioxide that is substantially dissolved in the reaction medium is provided.

As used herein the term isoolefin denotes compounds comprising one carbon-carbon-double-bond, wherein one carbon-atom of the double-bond is substituted by two alkyl-groups and the other carbon atom is substituted by two hydrogen atoms or by one hydrogen atom and one alkyl-group.

Examples of suitable isoolefins include isoolefins having from 4 to 16 carbon atoms, preferably 4 to 7 carbon atoms, such as isobutene, 2-methyl-1-butene, 3-methyl-1-butene, 2-methyl-2-butene. A preferred isolefin is isobutene.

The reaction medium may comprise further monomers that are copolymerized with the at least one isoolefin. Such further monomers include multiolefins.

As used herein the term multiolefin denotes compounds comprising more than one carbon-carbon-double-bond, either conjugated or non-conjugated.

Examples of suitable multiolefins include isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 4-butyl-1,3-pentadiene, 2,3-dimethyl-1,3-pentadiene, 2,3-dibutyl-1,3-pentadiene, 2-ethyl-1,3-pentadiene, 2-ethyl-1,3-butadiene, 2-methyl-1,6-heptadiene, cyclopentadiene, methylcyclopentadiene, cyclohexadiene and 1-vinyl-cyclohexadiene.

Preferred multiolefins are isoprene and butadiene. Isoprene is particularly preferred.

The reaction medium may comprise further monomers that are copolymerized with the at least one isoolefin and are neither isoolefins nor multiolefins. Such further monomers include β-pinene, styrene, divinylbenzene, diisopropenylbenzene o-, m- and p-alkylstyrenes such as o-, m- and p-methyl-styrene.

In one embodiment isobutene is used as sole monomer, where sole denotes a fraction of 99.9 wt.-% or more of all monomers employed.

In another embodiment, the monomers employed in step a) may comprise in the range of from 80 wt.-% to 99.5 wt.-%, preferably of from 85 wt.-% to 98.0 wt.-%, more preferably of from 85 wt.-% to 96.5 wt.-%, even more preferably of from 85 wt.-% to 95.0 wt.-%, by weight of at least one isoolefin and in the range of from 0.5 wt.-% to 20 wt.-%, preferably of from 2.0 wt.-% to 15 wt.-%, more preferably of from 3.5 wt.-% to 15 wt.-%, and yet even more preferably of from 5.0 wt.-% to 15 wt.-% by weight of at least one multiolefin based on the weight sum of all monomers employed.

In another embodiment the monomer mixture comprises in the range of from 90 wt.-% to 95 wt.-% of at least one isoolefin and in the range of from 5 wt.-% to 10 wt.-% by weight of a multiolefin based on the weight sum of all monomers employed. Yet more preferably, the monomer mixture comprises in the range of from 92 wt.-% to 94 wt.-% of at least one isoolefin and in the range of from 6 wt.-% to 8 wt.-% by weight of at least one multiolefin monomer based on the weight sum of all monomers employed. The isoolefin is preferably isobutene and the multiolefin is preferably isoprene.

Where at least one multiolefin is employed in the reaction medium the multiolefin content of the final copolymers produced are typically 0.1 mol-% or more, preferably of from 0.1 mol-% to 15 mol-%, in another embodiment 0.5 mol-% or more, preferably of from 0.5 mol-% to 10 mol-%, in another embodiment 0.7 mol-% or more, preferably of from 0.7 to 8.5 mol-% in particular of from 0.8 to 1.5 or from 1.5 to 2.5 mol-% or of from 2.5 to 4.5 mol-% or from 4.5 to 8.5 mol-%, particularly where isobutene and isoprene are employed.

In another embodiment the multiolefin content of copolymers produced according to the invention is 0.1 mol-% or more, preferably of from 0.1 mol-% to 3 mol-%, particularly where isobutene and isoprene are employed.

In one embodiment the monomers are purified before use in step a), in particular when they are recycled from optional step c). Purification of monomers may be carried out by passing through adsorbent columns containing suitable molecular sieves or alumina based adsorbent materials. In order to minimize interference with the polymerization reaction, the total concentration of water and substances such as alcohols and other organic oxygenates that act as poisons to the reaction are preferably reduced to less than around 10 parts per million on a weight basis.

### Organic Diluents

The term organic diluent encompasses diluting or dissolving organic chemicals which are liquid under reactions conditions. Any suitable organic diluent may be used which does not or not to any appreciable extent react with monomers or components of the initiator system.

However, those skilled in the art are aware that interactions between the diluent and monomers or components of the initiator system.

Additionally, the term organic diluent includes mixtures of at least two diluents.

Examples of organic diluents include hydrochlorocarbon(s) such as methyl chloride, methylene chloride or ethyl chloride.

Further examples of organic diluents include hydrofluorocarbons represented by the formula: CₓH_{y}F_{z} wherein x is an integer from 1 to 40, alternatively from 1 to 30, alternatively from 1 to 20, alternatively from 1 to 10, alternatively from 1 to 6, alternatively from 2 to 20 alternatively from 3 to 10, alternatively from 3 to 6, most preferably from 1 to 3, wherein y and z are integers and at least one.

In one embodiment the hydrofluorocarbon(s) is/are selected from the group consisting of saturated hydrofluorocarbons such as fluoromethane; difluoromethane; trifluoromethane; fluoroethane; 1,1-difluoroethane; 1,2-difluoroethane; 1,1,1-trifluoroethane; 1,1-,2-trifluoroethane; 1,1,2,2-tetrafluoroethane; 1,1,1,2,2-pentafluoroethane; 1-fluoropropane; 2-fluoropropane; 1,1-difluoropropane; 1,2-difluoropropane; 1,3-difluoropropane; 2,2-difluoropropane; 1,1,1-trifluoropropane; 1,1,2-trifluoropropane; 1,1,3-trifluoropropane; 1,2,2-trifluoropropane; 1,2,3-trifluoropropane; 1,1,1,2-tetrafluoropropane; 1,1,1,3-tetrafluoropropane; 1,1,2,2-tetrafluoropropane; 1,1,2,3-tetrafluoropropane; 1,1,3,3-tetrafluoropropane; 1,2,2,3-tetrafluoropropane; 1,1,1,2,2-pentafluoropropane; 1,1,1,2,3-pentafluoropropane; 1,1,1,3,3-pentafluoropropane; 1,1,2,2,3-pentafluoropropane; 1,1,2,3,3-pentafluoropropane; 1,1,1,2,2,3-hexafluoropropane; 1,1,1,2,3,3-hexafluoropropane; 1,1,1,3,3,3-hexafluoropropane; 1,1,1,2,2,3,3-heptafluoropropane; 1,1,1,2,3,3,3-heptafluoropropane; 1-fluorobutane; 2-fluorobutane; 1,1-difluorobutane; 1,2-difluorobutane; 1,3-difluorobutane; 1,4-difluorobutane; 2,2-difluorobutane; 2,3-difluorobutane; 1,1,1-trifluorobutane; 1,1,2-trifluorobutane; 1,1,3-trifluorobutane; 1,1,4-trifluorobutane; 1,2,2-trifluorobutane; 1,2,3-trifluorobutane; 1,3,3-trifluorobutane; 2,2,3-trifluorobutane; 1,1,1,2-tetrafluorobutane; 1,1,1,3-tetrafluorobutane; 1,1,1,4-tetrafluorobutane; 1,1,2,2-tetrafluorobutane; 1,1,2,3-tetrafluorobutane; 1,1,2,4-tetrafluorobutane; 1,1,3,3-tetrafluorobutane; 1,1,3,4-tetrafluorobutane; 1,1,4,4-tetrafluorobutane; 1,2,2,3-tetrafluorobutane; 1,2,2,4-tetrafluorobutane; 1,2,3,3-tetrafluorobutane; 1,2,3,4-tetrafluorobutane; 2,2,3,3-tetrafluorobutane; 1,1,1,2,2-pentafluorobutane; 1,1,1,2,3-pentafluorobutane; 1,1,1,2,4-pentafluorobutane; 1,1,1,3,3-pentafluorobutane; 1,1,1,3,4-pentafluorobutane; 1,1,1,4,4-pentafluorobutane; 1,1,2,2,3-pentafluorobutane; 1,1,2,2,4-pentafluorobutane; 1,1,2,3,3-pentafluorobutane; 1,1,2,4,4-pentafluorobutane; 1,1,3,3,4-pentafluorobutane; 1,2,2,3,3-pentafluorobutane; 1,2,2,3,4-pentafluorobutane; 1,1,1,2,2,3-hexafluorobutane; 1,1,1,2,2,4-hexafluorobutane; 1,1,1,2,3,3-hexafluorobutane, 1,1,1,2,3,4-hexafluorobutane; 1,1,1,2,4,4-hexafluorobutane; 1,1,1,3,3,4-hexafluorobutane; 1,1,1,3,4,4-hexafluorobutane; 1,1,1,4,4,4-hexafluorobutane; 1,1,2,2,3,3-hexafluorobutane; 1,1,2,2,3,4-hexafluorobutane; 1,1,2,2,4,4-hexafluorobutane; 1,1,2,3,3,4-hexafluorobutane; 1,1,2,3,4,4-hexafluorobutane; 1,2,2,3,3,4-hexafluorobutane; 1,1,1,2,2,3,3-heptafluorobutane; 1,1,1,2,2,4,4-heptafluorobutane; 1,1,1,2,2,3,4-heptafluorobutane; 1,1,1,2,3,3,4-heptafluorobutane; 1,1,1,2,3,4,4-heptafluorobutane; 1,1,1,2,4,4,4-heptafluorobutane; 1,1,1,3,3,4,4-heptafluorobutane; 1,1,1,2,2,3,3,4-octafluorobutane; 1,1,1,2,2,3,4,4-octafluorobutane; 1,1,1,2,3,3,4,4-octafluorobutane; 1,1,1,2,2,4,4,4-octafluorobutane; 1,1,1,2,3,4,4,4-octafluorobutane; 1,1,1,2,2,3,3,4,4-nonafluorobutane; 1,1,1,2,2,3,4,4,4-nonafluorobutane; 1-fluoro-2-methylpropane; 1,1-difluoro-2-methylpropane; 1,3-difluoro-2-ethylpropane; 1,1,1-trifluoro-2-methylpropane; 1,1,3-trifluoro-2-methylpropane; 1,3-difluoro-2-(fluoromethyl)propane; 1,1,1,3-tetrafluoro-2-methylpropane; 1,1,3,3-tetrafluoro-2-methylpropane; 1,1,3-trifluoro-2-(fluoromethyl)propane; 1,1,1,3,3-pentafluoro-2-methylpropane; 1,1,3,3-tetrafluoro-2-(fluoromethyl)propane; 1,1,1,3-tetrafluoro-2-(fluoromethyl)propane; fluorocyclobutane; 1,1-difluorocyclobutane; 1,2-difluorocyclobutane; 1,3-difluorocyclobutane; 1,1,2-trifluorocyclobutane; 1,1,3-trifluorocyclobutane; 1,2,3-trifluorocyclobutane; 1,1,2,2-tetrafluorocyclobutane; 1,1,3,3-tetrafluorocyclobutane; 1,1,2,2,3-pentafluorocyclobutane; 1,1,2,3,3-pentafluorocyclobutane; 1,1,2,2,3,3-hexafluorocyclobutane; 1,1,2,2,3,4-hexafluorocyclobutane; 1,1,2,3,3,4-hexafluorocyclobutane; 1,1,2,2,3,3,4-heptafluorocyclobutane;

[symbol]

Particularly preferred HFC's include difluoromethane, trifluoromethane, 1,1-difluoroethane, 1,1,1-trifluoro ethane, fluoromethane, and 1,1,1,2-tetrafluoro ethane.

In one further embodiment the hydrofluorocarbon(s) is/are selected from the group consisting of unsaturated hydrofluorocarbons such as vinyl fluoride; 1,2-difluoroethene; 1,1,2-trifluoroethene; 1-fluoropropene, 1,1-difluoropropene; 1,2-difluoropropene; 1,3-difluoropropene; 2,3-difluoropropene; 3,3-difluoropropene; 1,1,2-trifluoropropene; 1,1,3-trifluoropropene; 1,2,3-trifluoropropene; 1,3,3-trifluoropropene; 2,3,3-trifluoropropene; 3,3,3-trifluoropropene; 2,3,3,3-tetrafluoro-1-propene; 1-fluoro-1-butene; 2-fluoro-1-butene; 3-fluoro-1-butene; 4-fluoro-1-butene; 1,1-difluoro-1-butene; 1,2-difluoro-1-butene; 1,3-difluoropropene; 1,4-difluoro-1-butene; 2,3-difluoro-1-butene; 2,4-difluoro-1-butene; 3,3-difluoro-1-butene; 3,4-difluoro-1-butene; 4,4-difluoro-1-butene; 1,1,2-trifluoro-1-butene; 1,1,3-trifluoro-1-butene; 1,1,4-trifluoro-1-butene; 1,2,3-trifluoro-1-butene; 1,2,4-trifluoro-1-butene; 1,3,3-trifluoro-1-butene; 1,3,4-trifluoro-1-butene; 1,4,4-trifluoro-1-butene; 2,3,3-trifluoro-1-butene; 2,3,4-trifluoro-1-butene; 2,4,4-trifluoro-1-butene; 3,3,4-trifluoro-1-butene; 3,4,4-trifluoro-1-butene; 4,4,4-trifluoro-1-butene; 1,1,2,3-tetrafluoro-1-butene; 1,1,2,4-tetrafluoro-1-butene; 1,1,3,3-tetrafluoro-1-butene; 1,1,3,4-tetrafluoro-1-butene; 1,1,4,4-tetrafluoro-1-butene; 1,2,3,3-tetrafluoro-1-butene; 1,2,3,4-tetrafluoro-1-butene; 1,2,4,4-tetrafluoro-1-butene; 1,3,3,4-tetrafluoro-1-butene; 1,3,4,4-tetrafluoro-1-butene; 1,4,4,4-tetrafluoro-1-butene; 2,3,3,4-tetrafluoro-1-butene; 2,3,4,4-tetrafluoro-1-butene; 2,4,4,4-tetrafluoro-1-butene; 3,3,4,4-tetrafluoro-1-butene; 3,4,4,4-tetrafluoro-1-butene; 1,1,2,3,3-pentafluoro-1-butene; 1,1,2,3,4-pentafluoro-1-butene; 1,1,2,4,4-pentafluoro-1-butene; 1,1,3,3,4-pentafluoro-1-butene; 1,1,3,4,4-pentafluoro-1-butene; 1,1,4,4,4-pentafluoro-1-butene; 1,2,3,3,4-pentafluoro-1-butene; 1,2,3,4,4-pentafluoro-1-butene; 1,2,4,4,4-pentafluoro-1-butene; 2,3,3,4,4-pentafluoro-1-butene; 2,3,4,4,4-pentafluoro-1-butene; 3,3,4,4,4-pentafluoro-1-butene; 1,1,2,3,3,4-hexafluoro-1-butene; 1,1,2,3,4,4-hexafluoro-1-butene; 1,1,2,4,4,4-hexafluoro-1-butene; 1,2,3,3,4,4-bexafluoro-1-butene; 1,2,3,4,4,4-hexafluoro-1-butene; 2,3,3,4,4,4-hexafluoro-1-butene; 1,1,2,3,3,4,4-heptafluoro-1 -butene; 1,1,2,3,4,4,4-heptafluoro-1-butene; 1,1,3,3,4,4,4-heptafluoro-1-butene; 1,2,3,3,4,4,4-heptafluoro-1-butene; 1-fluoro-2-butene; 2-fluoro-2-butene; 1,1-difluoro-2-butene; 1,2-difluoro-2-butene; 1,3-difluoro-2-butene; 1,4-difluoro-2-butene; 2,3-difluro-2-butene; 1,1,1-trifluoro-2-butene; 1,1,2-trifluoro-2-butene; 1,1,3-trifluoro-2-butene; 1,1,4-trifluoro-2-butene; 1,2,3-trifluoro-2-butene; 1,2,4-trifluoro-2-butene; 1,1,1,2-tetrafluoro-2-butene; 1,1,1,3-tetrafluoro -2-butene; 1,1,1,4-tetrafluoro-2-butene; 1,1,2,3-tetrafluoro-2-butene; 1,1,2,4-tetrafluoro -2-butene; 1,2,3,4-tetrafluoro-2-butene; 1,1,1,2,3-pentafluoro-2-butene; 1,1,1,2,4-pentafluoro-2-butene; 1,1,1,3,4-pentafluoro-2-butene; 1,1,1,4,4-pentafluoro-2-butene; 1,1,2,3,4-pentafluoro-2-butene; 1,1,2,4,4-pentafluoro-2-butene; 1,1,1,2,3,4-hexafiuoro-2-butene; 1,1,1,2,4,4-hexafluoro-2-butene; 1,1,1,3,4,4-hexafluoro-2-butene; 1,1,1,4,4,4-hexafluoro-2-butene; 1,1,2,3,4,4-hexafluoro-2-butene; 1,1,1,2,3,4,4-heptafluoro-2-butene; 1,1,1,2,4,4,4-heptafluoro-2-butene; and mixtures thereof.

Further examples of organic diluents include hydrochlorofluorocarbons.

Further examples of organic diluents include hydrocarbons, preferably alkanes which in a further preferred embodiment are those selected from the group consisting of n-butane, isobutane, n-pentane, methycyclopentane, isohexane, 2-methylpentane, 3-methylpentane, 2-methylbutane, 2,2-dimethylbutane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethyl pentane, 2-methylheptane, 3-ethylhexane, 2,5-dimethylhexane, 2,2,4,-trimethylpentane, octane, heptane, butane, nonane, decane, dodecane, undecane, hexane, methyl cyclohexane, cyclopentane, methylcyclopentane, 1,1-dimethylcycopentane, cis-1,2-dimethylcyclopentane, trans-1,2-dimethylcyclopentane, trans-1,3-dimethyl-cyclopentane, ethylcyclopentane, cyclohexane, methylcyclohexane.

Further examples of hydrocarbon diluents include benzene, toluene, xylene, ortho-xylene, para-xylene and meta-xylene.

Suitable organic diluents further include mixtures of at least two compounds selected from the groups of hydrochlorocarbons, hydrofluorocarbons, hydrochlorofluorocarbons and hydrocarbons. Specific combinations include mixtures of hydrochlorocarbons and hydrofluorocarbons such as mixtures of methyl chloride and 1,1,1,2-tetrafluoroethane, in particular those of 40 to 60 vol.-% methyl chloride and 40 to 60 vol.-% 1,1,1,2-tetrafluoroethane whereby the aforementioned two diluents add up to 90 to 100 vol.-%, preferably to 95 to 100 vol. % of the total diluent, whereby the potential remainder to 100 vol. % includes other halogenated hydrocarbons; or mixtures of methyl chloride and at least one alkane or mixtures of alkanes such as mixtures comprising at least 90 wt.-%, preferably 95 wt.-% of alkanes having a boiling point at a pressure of 1013 hPa of −5° C. to 100° C. or in another embodiment 35° C. to 85° C. In another embodiment least 99,9 wt.-%, preferably 100 wt.-% of the alkanes have a boiling point at a pressure of 1013 hPa of 100° C. or less, preferably in the range of from 35 to 100° C., more preferably 90° C. or less, even more preferably in the range of from 35 to 90° C.

Depending on the nature of the polymerization intended for step b) the organic diluent is selected to allow a slurry polymerization or a solution polymerization.

### Carbon Dioxide and Ethane

The reaction medium further comprises ethane or carbon dioxide that is substantially dissolved in the reaction medium.

As used herein “substantially dissolved” means that means that more than 50 wt.-%, preferably at least 70 wt.-%, preferably at least 80 wt.-%, more preferably at least 90 wt.-% and even more preferably at least 95 wt.-% of the ethane or carbon dioxide present in the reaction medium is dissolved therein. The remainder may be solid carbon dioxide e.g. suspended in the reaction medium. In a preferred embodiment the reaction medium contains no solid carbon dioxide and tis homogenous.

In one embodiment, where desired or required additional ethane or carbon dioxide may be added during step b). This addition may be effect for example by injecting liquid ethane or carbon dioxide or adding a solution of carbon dioxide in an organic diluent as described above.

### The Reaction Medium

The monomer(s) may be present in the reaction medium in an amount of from 0.01 wt.-% to 80 wt.-%, preferably of from 0.1 wt.-% to 65 wt.-%, more preferably of from 10.0 wt.-% to 65.0 wt.-% and even more preferably of from 25.0 wt.-% to 65.0 wt.-%, or in another embodiment of from 10.0 wt.-% to 40.0 wt.-%.

The organic diluent may be present in the reaction medium in an amount of from 0.01 wt.-% to 80 wt.-%, preferably of from 0.1 wt.-% to 65 wt.-%, more preferably of from 10.0 wt.-% to 65.0 wt.-% and even more preferably of from 25.0 wt.-% to 65.0 wt.-%, or in another embodiment of from 10.0 wt.-% to 40.0 wt.-%.

Ethane or Carbon dioxide may be present in the reaction medium in an amount of from 0.01 wt.-% to 20 wt.-%, preferably of from 0.01 wt.-% to 12 wt.-%, more preferably of from 1.0 wt.-% to 12.0 wt.-% and even more preferably of from 5.0 wt.-% to 11.0 wt.-%, or in another embodiment of from 5.5 wt.-% to 12.0 wt.-%.

The amounts of organic diluent, the monomers and the ethane or the carbon dioxide are selected such that they make up at least 95 wt.-%, preferably 97 to 100 wt.-% and more preferably 99 to 100 wt. % of the reaction medium employed in step b).

The remainder to 100% may comprise other organic or inorganic compounds, preferably those virtually not affecting the polymerization reaction.

In one embodiment the reaction medium comprises of from 10.0 wt.-% to 65.0 wt.-% of monomer(s), of from 20.0 wt.-% to 89.9 wt.-% of organic diluent and of from 0.1 wt.-% to 15.0 wt.-% of carbon dioxide whereby the amounts of organic diluent, the monomer(s) and carbon dioxide are selected such that they make up at least 95 wt.-%, preferably 97 to 100 wt.-% and more preferably 99 to 100 wt. % of the reaction medium

In another embodiment the reaction medium comprises of from 10.0 wt.-% to 65.0 wt.-% of monomer(s), of from 20.0 wt.-% to 89.9 wt.-% of organic diluent and of from 0.1 wt.-% to 15.0 wt.-% of ethane or carbon dioxide whereby the amounts of organic diluent, the monomer(s) and ethane or carbon dioxide are selected such that they make up at least 95 wt.-%, preferably 97 to 100 wt.-% and more preferably 99 to 100 wt. % of the reaction medium

The reaction medium may be prepared for example by mixing the organic diluent and the monomer(s) and then conveying the resulting mixture over a bed of solid carbon dioxide to allow dissolution of the carbon dioxide into the reaction medium to the desired level. It is typically advantageous to pre-cool the monomer(s), the organic diluent or the mixture thereof to avoid to much consumption of carbon dioxide for cooling down the whole reaction medium.

A suitable temperature for pre-cooling is typically in the range of from 0 to −100°, preferably in the range of from −20 to −80° C., more preferably of from −50° C. to −80° C.

### Initiator System

In step b) the monomer(s) within the reaction medium are polymerized in the presence of an initiator system to form a product medium comprising the polymer, the organic diluent and optionally residual monomers.

The initiator system comprises at least one Lewis acid and an initiator.

### Lewis Acids

Suitable Lewis acids include compounds represented by formula MX₃, where M is a group 13 element and X is a halogen. Examples for such compounds include aluminum trichloride, aluminum tribromide, boron trichloride, boron tribromide, gallium trichloride and indium trifluoride, whereby aluminum trichloride is preferred.

Further suitable Lewis acids include compounds represented by formula MR₍ₘ₎X₍₃₋ₘ₎, where M is a group 13 element, X is a halogen, R is a monovalent hydrocarbon radical selected from the group consisting of C₁-C₁₂ alkyl, C₆-C₁₀ aryl, C₇-C₁₄ arylalkyl and C₇-C₁₄ alkylaryl radicals; and and m is one or two. X may also be an azide, an isocyanate, a thiocyanate, an isothiocyanate or a cyanide.

Examples for such compounds include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride and any mixture thereof. Preferred are diethyl aluminum chloride (Et₂AlCl or DEAC), ethyl aluminum sesquichloride (Et_{1.5}AlCl_{1.5} or EASC), ethyl aluminum dichloride (EtAlCl₂ or EADC), diethyl aluminum bromide (Et₂AlBr or DEAB), ethyl aluminum sesquibromide (Et_{1.5}AlBr_{1.5} or EASB) and ethyl aluminum dibromide (EtAlBr₂ or EADB) and any mixture thereof.

Further suitable Lewis acids include compounds represented by formula M(RO)ₙR′ₘX₍₃₋₍ₘ₊ₙ₎₎; wherein M is a Group 13 metal; wherein RO is a monovalent hydrocarboxy radical selected from the group consisting of C₁-C₃₀ alkoxy, C₇-C₃₀ aryloxy, C₇-C₃₀ arylalkoxy, C₇-C₃₀ alkylaryloxy; R′ is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is a number from 0 to 3 and m is an number from 0 to 3 such that the sum of n and m is not more than 3;

X is a halogen independently selected from the group consisting of fluorine, chlorine, bromine, and iodine, preferably chlorine. X may also be an azide, an isocyanate, a thiocyanate, an isothiocyanate or a cyanide.

For the purposes of this invention, one skilled in the art would recognize that the terms alkoxy and aryloxy are structural equivalents to alkoxides and phenoxides respectively. The term “arylalkoxy” refers to a radical containing both aliphatic and aromatic structures, the radical being at an alkoxy position. The term “alkylaryl” refers to a radical containing both aliphatic and aromatic structures, the radical being at an aryloxy position.

Non-limiting examples of these Lewis acids include methoxyaluminum dichloride, ethoxyaluminum dichloride, 2,6-di-tert-butylphenoxyaluminum dichloride, methoxy methylaluminum chloride, 2,6-di-tert-butylphenoxy methylaluminum chloride, isopropoxygallium dichloride and phenoxy methylindium fluoride.

Further suitable Lewis acids include compounds represented by formula M(RC═OO)ₙR′ₘX₍₃₋₍ₘ₊ₙ₎₎ wherein M is a Group 13 metal; wherein RC═OO is a monovalent hydrocarbacyl radical selected from the group selected from the group consisting of C₁-C₃₀ alkacyloxy, C₇-C₃₀ arylacyloxy, C₇-C₃₀ arylalkylacyloxy, C₇-C₃₀ alkylarylacyloxy radicals; R′ is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is a number from 0 to 3 and m is a number from 0 to 3 such that the sum of n and m is not more than 3; X is a halogen independently selected from the group consisting of fluorine, chlorine, bromine, and iodine, preferably chlorine. X may also be an azide, an isocyanate, a thiocyanate, an isothiocyanate or a cyanide.

The term “arylalkylacyloxy” refers to a radical containing both aliphatic and aromatic structures, the radical being at an alkyacyloxy position. The term “alkylarylacyloxy” refers to a radical containing both aliphatic and aromatic structures, the radical being at an arylacyloxy position. Non-limiting examples of these Lewis acids include acetoxyaluminum dichloride, benzoyloxyaluminum dibromide, benzoyloxygallium difluoride, methyl acetoxyaluminum chloride, and isopropoyloxyindium trichloride.

Further suitable Lewis acids include compounds based on metals of Group 4, 5, 14 and 15 of the Periodic Table of the Elements, including titanium, zirconium, tin, vanadium, arsenic, antimony, and bismuth.

One skilled in the art will recognize, however, that some elements are better suited in the practice of the invention. The Group 4, 5 and 14 Lewis acids have the general formula MX₄; wherein M is Group 4, 5, or 14 metal; and X is a halogen independently selected from the group consisting of fluorine, chlorine, bromine, and iodine, preferably chlorine. X may also be a azide, an isocyanate, a thiocyanate, an isothiocyanate or a cyanide. Non-limiting examples include titanium tetrachloride, titanium tetrabromide, vanadium tetrachloride, tin tetrachloride and zirconium tetrachloride. The Group 4, 5, or 14 Lewis acids may also contain more than one type of halogen. Non-limiting examples include titanium bromide trichloride, titanium dibromide dichloride, vanadium bromide trichloride, and tin chloride trifluoride.

Group 4, 5 and 14 Lewis acids useful in this invention may also have the general formula MRₙX_{(4-n);} wherein M is Group 4, 5, or 14 metal; wherein R is a monovalent hydrocarbon radical selected from the group consisting of C₁-C₁₂ alkyl, C₆-C₁₀ aryl, C₇-C₁₄ arylalkyl and C₇-C₁₄ alkylaryl radicals; n is an integer from 0 to 4; X is a halogen independently selected from the group consisting of fluorine, chlorine, bromine, and iodine, preferably chlorine. X may also be an azide, an isocyanate, a thiocyanate, an isothiocyanate or a cyanide.

The term “arylalkyl” refers to a radical containing both aliphatic and aromatic structures, the radical being at an alkyl position.

The term “alkylaryl” refers to a radical containing both aliphatic and aromatic structures, the radical being at an aryl position.

Non-limiting examples of these Lewis acids include benzyltitanium trichloride, dibenzyltitanium dichloride, benzylzirconium trichloride, dibenzylzirconium dibromide, methyltitanium trichloride, dimethyltitanium difluoride, dimethyltin dichloride and phenylvanadium trichloride.

Group 4, 5 and 14 Lewis acids useful in this invention may also have the general formula M(RO)ₙR′ₘX_{4-(m+n);} wherein M is Group 4, 5, or 14 metal, wherein RO is a monovalent hydrocarboxy radical selected from the group consisting of C₁-C₃₀ alkoxy, C₇-C₃₀ aryloxy, C₇-C₃₀ arylalkoxy, C₇-C₃₀ alkylaryloxy radicals; R′ is a monovalent hydrocarbon radical selected from the group consisting of [symbol] , R is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is an integer from 0 to 4 and m is an integer from 0 to 4 such that the sum of n and m is not more than 4; X is selected from the group consisting of fluorine, chlorine, bromine, and iodine, preferably chlorine. X may also be an azide, an isocyanate, a thiocyanate, an isothiocyanate or a cyanide.

For the purposes of this invention, one skilled in the art would recognize that the terms alkoxy and aryloxy are structural equivalents to alkoxides and phenoxides respectively. The term “arylalkoxy” refers to a radical containing both aliphatic and aromatic structures, the radical being at an alkoxy position.

The term “alkylaryl” refers to a radical containing both aliphatic and aromatic structures, the radical being at an aryloxy position. Non-limiting examples of these Lewis acids include methoxytitanium trichloride, n-butoxytitanium trichloride, di(isopropoxy)titanium dichloride, phenoxytitanium tribromide, phenylmethoxyzirconium trifluoride, methyl methoxytitanium dichloride, methyl methoxytin dichloride and benzyl isopropoxyvanadium dichloride.

Group 4, 5 and 14 Lewis acids useful in this invention may also have the general formula M(RC═OO)ₙR′ₘX₄₋₍ₘ₊ₙ₎; wherein M is Group 4, 5, or 14 metal; wherein RC═OO is a monovalent hydrocarbacyl radical selected from the group consisting of C₁-C₃₀ alkacyloxy, C₇-C₃₀ arylacyloxy, C₇-C₃₀ arylalkylacyloxy, C₇-C₃₀ alkylarylacyloxy radicals; R′ is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is an integer from 0 to 4 and m is an integer from 0 to 4 such that the sum of n and m is not more than 4; X is a halogen independently selected from the group consisting of fluorine, chlorine, bromine, and iodine, preferably chlorine. X may also be an azide, an isocyanate, a thiocyanate, an isothiocyanate or a cyanide.

The term “arylalkylacyloxy” refers to a radical containing both aliphatic and aromatic structures, the radical being at an alkylacyloxy position.

The term “alkylarylacyloxy” refers to a radical containing both aliphatic and aromatic structures, the radical being at an arylacyloxy position. Non-limiting examples of these Lewis acids include acetoxytitanium trichloride, benzoylzirconium tribromide, benzoyloxytitanium trifluoride, isopropoyloxytin trichloride, methyl acetoxytitanium dichloride and benzyl benzoyloxyvanadium chloride.

Group 5 Lewis acids useful in this invention may also have the general formula MOX₃; wherein M is a Group 5 metal and wherein X is a halogen independently selected from the group consisting of fluorine, chlorine, bromine, and iodine, preferably chlorine. A non-limiting example is vanadium oxytrichloride. The Group 15 Lewis acids have the general formula MX_{y}, wherein M is a Group 15 metal and X is a halogen independently selected from the group consisting of fluorine, chlorine, bromine, and iodine, preferably chlorine and y is 3, 4 or 5. X may also be an azide, an isocyanate, a thiocyanate, an isothiocyanate or a cyanide. Non-limiting examples include antimony hexachloride, antimony hexafluoride, and arsenic pentafluoride. The Group 15 Lewis acids may also contain more than one type of halogen. Non-limiting examples include antimony chloride pentafluoride, arsenic trifluoride, bismuth trichloride and arsenic fluoride tetrachloride.

Group 15 Lewis acids useful in this invention may also have the general formula MRₙX_{y-n;} wherein M is a Group 15 metal; wherein R is a monovalent hydrocarbon radical selected from the group consisting of C₁-C₁₂ alkyl, C₆-C₁₀ aryl, C₇-C₁₄ arylalkyl and C₇-C₁₄ alkylaryl radicals; and n is an integer from 0 to 4; y is 3, 4 or 5 such that n is less than y; X is a halogen independently selected from the group consisting of fluorine, chlorine, bromine, and iodine, preferably chlorine. X may also be a an azide, an isocyanate, a thiocyanate, an isothiocyanate or a cyanide. The term “arylalkyl” refers to a radical containing both aliphatic and aromatic structures, the radical being at an alkyl position. The term “alkylaryl” refers to a radical containing both aliphatic and aromatic structures, the radical being at an aryl position. Non-limiting examples of these Lewis acids include tetraphenylantimony chloride and triphenylantimony dichloride.

Group 15 Lewis acids useful in this invention may also have the general formula M(RO)ₙR′ₘX_{y-(m+n);} wherein M is a Group 15 metal, wherein RO is a monovalent hydrocarboxy radical selected from the group consisting of C₁-C₃₀ alkoxy, C₇-C₃₀ aryloxy, C₇-C₃₀ arylalkoxy, C₇-C₃₀ alkylaryloxy radicals; R′ is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is an integer from 0 to 4 and m is an integer from 0 to 4 and y is 3, 4 or 5 such that the sum of n and m is less than y; X is a halogen independently selected from the group consisting of fluorine, chlorine, bromine, and iodine, preferably chlorine. X may also be an azide, an isocyanate, a thiocyanate, an isothiocyanate or a cyanide. For the purposes of this invention, one skilled in the art would recognize that the terms alkoxy and aryloxy are structural equivalents to alkoxides and phenoxides respectively. The term “arylalkoxy” refers to a radical containing both aliphatic and aromatic structures, the radical being at an alkoxy position. The term “alkylaryl” refers to a radical containing both aliphatic and aromatic structures, the radical being at an aryloxy position. Non-limiting examples of these Lewis acids include tetrachloromethoxyantimony, dimethoxytrichloroantimony, dichloromethoxyarsine, chlorodimethoxyarsine, and difluoromethoxyarsine. Group 15 Lewis acids useful in this invention may also have the general formula M(RC═OO)ₙR′ₘX_{y-(m+n)}; wherein M is a Group 15 metal; wherein RC═OO is a monovalent hydrocarbacyloxy radical selected from the group consisting of C₁-C₃₀ alkacyloxy, C₇-C₃₀ arylacyloxy, C₇-C₃₀ arylalkylacyloxy, C₇-C₃₀ alkylarylacyloxy radicals; R′ is a monovalent hydrocarbon radical selected from the group consisting of C₁-C₁₂ alkyl, C₆-C₁₀ aryl, C₇-C₁₄ arylalkyl and C₇-C₁₄ alkylaryl radicals as defined above; n is an integer from 0 to 4 and m is an integer from 0 to 4 and y is 3, 4 or 5 such that the sum of n and m is less than y; X is a halogen independently selected from the group consisting of fluorine, chlorine, bromine, and iodine, preferably chlorine. X may also be an azide, an isocyanate, a thiocyanate, an isothiocyanate or a cyanide. The term “arylalkylacyloxy” refers to a radical containing both aliphatic and aromatic structures, the radical being at an alkyacyloxy position. The term “alkylarylacyloxy” refers to a radical containing both aliphatic and aromatic structures, the radical being at an arylacyloxy position. Non-limiting examples of these Lewis acids include acetatotetrachloroantimony, (benzoato) tetrachloroantimony, and bismuth acetate chloride.

Lewis acids such as methylaluminoxane (MAO) and specifically designed weakly coordinating Lewis acids such as B(C₆F₅)₃ are also suitable Lewis acids within the context of the invention.

Weakly coordinating Lewis acids are exhaustively disclosed in WO 2004/067577A in sections [117] to [129] which are hereby incorporated by reference.

### Initiators

Initiators useful in this invention are those initiators which are capable of being complexed with the chosen Lewis acid to yield a complex which reacts with the monomers thereby forming a propagating polymer chain.

In a preferred embodiment the initiator comprises at least one compound selected from the groups consisting of water, hydrogen halides, carboxylic acids, carboxylic acid halides, sulfonic acids, sulfonic acid halides, alcohols, phenols, tertiary alkyl halides, tertiary aralkyl halides, tertiary alkyl esters, tertiary aralkyl esters, tertiary alkyl ethers, tertiary aralkyl ethers, alkyl halides, aryl halides, alkylaryl halides and arylalkylacid halides.

Preferred hydrogen halide initiators include hydrogen chloride, hydrogen bromide and hydrogen iodide. A particularly preferred hydrogen halide is hydrogen chloride.

Preferred carboxylic acids include both aliphatic and aromatic carboxylic acids. Examples of carboxylic acids useful in this invention include acetic acid, propanoic acid, butanoic acid; cinnamic acid, benzoic acid, 1-chloroacetic acid, dichloroacetic acid, trichloroacetic acid, trifluoroacetic acid, p-chlorobenzoic acid, and p-fluorobenzoic acid. Particularly preferred carboxylic acids include trichloroacetic acid, trifluoroacteic acid, and p-fluorobenzoic acid.

Carboxylic acid halides useful in this invention are similar in structure to carboxylic acids with the substitution of a halide for the OH of the acid. The halide may be fluoride, chloride, bromide, or iodide, with the chloride being preferred.

Carboxylic acid halides useful in this invention include acetyl chloride, acetyl bromide, cinnamyl chloride, benzoyl chloride, benzoyl bromide, trichloroacetyl chloride, trifluoroacetylchloride, trifluoroacetyl chloride and p-fluorobenzoylchloride. Particularly preferred acid halides include acetyl chloride, acetyl bromide, trichloroacetyl chloride, trifluoroacetyl chloride and p-fluorobenzoyl chloride.

Sulfonic acids useful as initiators in this invention include both aliphatic and aromatic sulfonic acids. Examples of preferred sulfonic acids include methanesulfonic acid, trifluoromethanesulfonic acid, trichloromethanesulfonic acid and p-toluenesulfonic acid.

Sulfonic acid halides useful in this invention are similar in structure to sulfonic acids with the substitution of a halide for the OH of the parent acid. The halide may be fluoride, chloride, bromide or iodide, with the chloride being preferred. Preparation of the sulfonic acid halides from the parent sulfonic acids are known in the prior art and one skilled in the art should be familiar with these procedures. Preferred sulfonic acid halides useful in this invention include methanesulfonyl chloride, methanesulfonyl bromide, trichloromethanesulfonyl chloride, trifluoromethanesulfonyl chloride and p-toluenesulfonyl chloride.

Alcohols useful in this invention include methanol, ethanol, propanol, 2-propanol, 2-methylpropan-2-ol, cyclohexanol, and benzyl alcohol.

Phenols useful in this invention include phenol; 2-methylphenol; 2,6-dimethylphenol; p-chlorophenol; p-fluorophenol; 2,3,4,5,6-pentafluorophenol; and 2-hydroxynaphthalene.

The initiator system may further comprise oxygen- or nitrogen-containing compounds other than the aforementioned to further incluence or enhance the activity.

Such compounds include ethers, amines, N-heteroaromatic compounds, ketones, sulfones and sulfoxides as well as carboxylic acid esters and amides

Ethers include methyl ethyl ether, diethyl ether, di-n-propyl ether, tert.-butyl-methyl ether, di-n-butyl ether, tetrahydrofurane, dioxane, anisole or phenetole.

Amines include n-pentyl amine, N,N-diethyl methylamine, N,N-dimethyl propylamine, N-methyl butylamine, N,N-dimethyl butylamine, N-ethyl butylamine, hexylamine, N-methyl hexylamine, N-butyl propylamine, heptyl amine, 2-amino heptane, 3-amino heptane, N,N-dipropyl ethyl amine, N,N-dimethyl hexylamine, octylamine, aniline, benzylamine, N-methyl aniline, phenethylamine, N-ethyl aniline, 2,6-diethyl aniline, amphetamine, N-propyl aniline, phentermine, N-butyl aniline, N,N-diethyl aniline, 2,6-diethyl aniline, diphenylamine, piperidine, N-methyl piperidine and triphenylamine.

N-heteroaromatic compounds include pyridine, 2-, 3- or 4-methyl pyridine, dimethyl pyridine, ethylene pyridine and 3-methyl-2-phenyl pyridine.

Ketones include acetone, butanone, pentanone, hexanone, cyclohexanone, 2,4-hexanedione, acetylacetone and acetonyl acetone.

Sulfones and sulfoxides include dimethyl sulfoxide, diethyl sulfoxide and sulfolane.

Carboxylic acid esters include methyl acetate, ethyl acetate, vinyl acetate, propyl acetate, allyl acetate, benzyl acetate, methyl acrylate, ethyl acrylate, propyl acrylate, butyl acrylate, methyl methacrylate, ethyl methacrylate, propyl methacrylate, butyl methacrylate, dimethyl maleate, diethyl maleate, dipropyl maleate, methyl benzoate, ethyl benzoate, propyl benzoate, butyl benzoate, allyl benzoate, butylidene benzoate, benzyl benzoate, phenylethyl benzoate, dimethyl phthalate, diethyl phthalate, dipropyl phthalate, dibutyl phthalate, dipentyl phthalate, dihexyl phthalate, diheptyl phthalate and dioctyl phthalate.

Carboxylic acid amides include N,N-dimethyl formamide, N,N-dimethyl acetamide, N,N-diethyl formamide and N,N-diethyl acetamide. Preferred tertiary alkyl and aralkyl initiators include tertiary compounds represented by the formula below: wherein X is a halogen, pseudohalogen, ether, or ester, or a mixture thereof, preferably a halogen, preferably chloride and R₁, R₂ and R₃ are independently any linear, cyclic or branched chain alkyls, aryls or arylalkyls, preferably containing 1 to 15 carbon atoms and more preferably 1 to 8 carbon atoms. n is the number of initiator sites and is a number greater than or equal to 1, preferably between 1 to 30, more preferably n is a number from 1 to 6. The arylalkyls may be substituted or unsubstituted. For the purposes of this invention and any claims thereto, arylalkyl is defined to mean a compound containing both aromatic and aliphatic structures. Preferred examples of initiators include 2-chloro-2,4,4-trimethylpentane; 2-bromo-2,4,4-trimethylpentane; 2-chloro-2-methylpropane; 2-bromo-2-methylpropane; 2-chloro-2,4,4,6,6-pentamethylheptane; 2-bromo-2,4,4,6,6-p entamethylheptane; 1-chloro-1-methylethylbenzene; 1-chloroadamantane; 1-chloroethylbenzene; 1,4-bis(1-chloro-1-methylethyl) benzene; 5-tert-butyl-1,3-bis(1-chloro-1-methylethyl) benzene; 2-acetoxy-2,4,4-trimethylpentane; 2-benzoyloxy-2,4,4-trimethylpentane; 2-acetoxy-2-methylpropane; 2-benzoyloxy-2-methylpropane; 2-acetoxy-2,4,4,6,6-pentamethylheptane; 2-benzoyl-2,4,4,6,6-pentamethylheptane; 1-acetoxy-1-methylethylbenzene; 1-aceotxyadamantane; 1-benzoyloxyethylbenzene; 1,4-bis(1-acetoxy-1-methylethyl) benzene; 5-tert-butyl-1,3-bis(1-acetoxy-1-methylethyl) benzene; 2-methoxy-2,4,4-trimethylpentane; 2-isopropoxy-2,4,4-trimethylpentane; 2-methoxy-2-methylpropane; 2-benzyloxy-2-methylpropane; 2-methoxy-2,4,4,6,6-pentamethylheptane; 2-isopropoxy-2,4,4,6,6-pentamethylheptane; 1-methoxy-1-methylethylbenzene; 1-methoxyadamantane; 1-methoxyethylbenzene; 1,4-bis(1-methoxy-1-methylethyl) benzene; 5-tert-butyl-1,3-bis(1-methoxy-1-methylethyl) benzene and 1,3,5-tris(1-chloro-l-methylethyl) benzene. Other suitable initiators can be found in U.S. Pat. No. 4,946,899. For the purposes of this invention and the claims thereto pseudohalogen is defined to be any compound that is an azide, an isocyanate, a thiocyanate, an isothiocyanate or a cyanide.

Another preferred initiator is a polymeric halide, one of R₁, R₂ or R₃ is an olefin polymer and the remaining R groups are defined as above. Preferred olefin polymers include polyisobutylene, polypropylene, and polyvinylchloride. The polymeric initiator may have halogenated tertiary carbon positioned at the chain end or along or within the backbone of the polymer. When the olefin polymer has multiple halogen atoms at tertiary carbons, either pendant to or within the polymer backbone, the product may contain polymers which have a comb like structure and/or side chain branching depending on the number and placement of the halogen atoms in the olefin polymer. Likewise, the use of a chain end tertiary polymer halide initiator provides a method for producing a product which may contain block copolymers.

Particularly preferred initiators may be any of those useful in cationic polymerization of isobutene and butyl rubber include: water, hydrogen chloride, 2-chloro-2,4,4-trimethylpentane, 2-chloro-2-methylpropane, 1-chloro-1-methylethylbenzene, and methanol.

Initiator systems useful in this invention may further comprise compositions comprising a reactive cation and a weakly-coordinating anion (“WCA”) as defined above.

A preferred mole ratio of Lewis acid to initiator is generally from 1:5 to 100:1 preferably from 5:1 to 100:1, more preferably from 8:1 to 20:1 or, in another embodiment, of from 1:1.5 to 15:1, preferably of from 1:1 to 10:1. The initiator system including the lewis acid and the initiator is preferably present in the reaction mixture in an amount of 0.002 to 5.0 wt.-%, preferably of 0.1 to 0.5 wt.-%, based on the weight of the monomers employed.

In another embodiment, in particular where aluminum trichloride is employed the wt.-ratio of monomers employed to lewis acid, in particular aluminum trichloride is within a range of 500 to 20000, preferably 1500 to 10000.

In a particularly preferred initiator system, the Lewis acid is ethyl aluminum sesquichloride, preferably generated by mixing equimolar amounts of diethyl aluminum chloride and ethyl aluminum dichloride, preferably in an organic diluent. The organic diluent is preferably the same one used to perform the polymerization in step b).

Where alkyl aluminum halides are employed water and/or alcohols, preferably water is used as proton source.

In one embodiment the amount of water is in the range of 0.40 to 4.0 moles of water per mole of aluminum of the alkyl aluminum halides, preferably in the range of 0.5 to 2.5 moles of water per mole of aluminum of the alkyl aluminum halides, most preferably 1 to 2 moles of water per mole of the alkyl aluminum halides.

Where aluminum halides, in particular aluminum trichloride are employed water and/or alcohols, preferably water is used as proton source.

In one embodiment the amount of water is in the range of 0.05 to 2.0 moles of water per mole of aluminum in the aluminum halides, preferably in the range of 0.1 to 1.2 moles of water per mole of aluminum in the aluminum halides.

### Polymerization Conditions

In one embodiment, the organic diluent and the monomers employed are substantially free of water. As used herein substantially free of water is defined as less than 30 ppm based upon total weight of the reaction medium, preferably less than 20 ppm, more preferably less than 10 ppm, even more preferably less than 5 ppm, and most preferably less than 1 ppm.

One skilled of the art is aware that the water content in the diluent and the monomers needs to be low to ensure that the initiator system is not affected by additional amounts of water which are not added by purpose e.g. to serve as an initiator.

Step b) may be carried out in continuous or batch processes, whereby a continuous operation is preferred.

In an embodiment of the invention the polymerization according to step b) is effected using a polymerization reactor. Suitable reactors are those known to the skilled in the art and include flow-through polymerization reactors, plug flow reactor, stirred tank reactors, moving belt or drum reactors, jet or nozzle reactors, tubular reactors, and autorefrigerated boiling-pool reactors. Specific suitable examples are disclosed in WO 2011/000922 A and WO 2012/089823 A.

In one embodiment, the polymerization according to step b) is carried out where the initiator system, the monomer(s), the organic diluent and carbon dioxide form a single phase.

Preferably, the polymerization is carried-out in a continuous polymerization process in which the initiator system, the monomer(s), the organic diluent and ethane or carbon dioxide form a single phase.

Depending on the choice of the organic diluent the polymerization according to step b) is carried out either as slurry polymerization or solution polymerization.

In slurry polymerization, the monomers, the initiator system are all typically soluble in the diluent or diluent mixture, i.e., constitute a single phase, while the copolymer upon formation precipitates from the organic diluent. Desirably, reduced or no polymer “swelling” is exhibited as indicated by little or no Tg suppression of the polymer and/or little or no organic diluent mass uptake.

In solution polymerization, the monomers, the initiator system are all typically soluble in the diluent or diluent mixture, i.e., constitute a single phase as is the copolymer formed during polymerization.

The solubilities of the desired polymers in the organic diluents described above as well as their swelling behaviour under reaction conditions is well known to those skilled in the art.

The advantages and disadvantages of solution versus slurry polymerization are exhaustively discussed in the literature and thus are also known to those skilled in the art.

Step b) is preferably carried out as solution process.

In one embodiment step b) is carried out at a temperature in the range of −90° C. to −60° C., preferably in the range of −80° C. to −62° C. and even more preferably in the range of −78° C. to −65° C.

In a preferred embodiment, the polymerization temperature is within 20° C. above the boiling point of the ethane or the carbon dioxide with the reaction mixture, preferably within 10° C. above the boiling point of the ethane or the carbon dioxide.

The reaction pressure in step b) is typically from 500 to 100,000 hP, preferably from 1100 to 20,000 hPa, more preferably from 1300 to 5,000 hPa.

Where the polymerization according to step b) is carried out as a slurry process the solids content of the slurry in step b) is preferably in the range of from 1 to 45 wt.-%, more preferably 3 to 40 wt.-%, even more preferably 15 to 40 wt.-%.

As used herein the terms “solids content” or “solids level” refer to weight percent of the polymer in the product medium comprising the polymer, the organic diluent and optionally residual monomer(s) obtained according to step b) but not considering the content of carbon dioxide that might be still present therein.

In one embodiment the reaction time in step b) is from 2 min to 2 h, preferably from 10 min to 1 h and more preferably from 20 to 45 min.

The process may be carried out batchwise or continuously. Where a continuous reaction is performed the reaction time given above represents the average residence time.

In one embodiment the reaction is stopped by quenching agents for example a 1 wt.-% sodium hydroxide solution in water, methanol or ethanol.

In another embodiment, the reaction is quenched by the contact with the aqueous medium in step c), which in one embodiment may have a pH value of 5 to 10, preferably 6 to 9 and more preferably 7 to 9 measured at 20° C. and 1013 hPa.

The pH-Adjustment where desired may be performed by addition of acids or alkaline compounds which preferably do not contain multivalent metal ions. pH adjustment to higher pH values is e.g. effected by addition of sodium or potassium hydroxide.

In particular for solution polymerizations the conversion is typically stopped after a monomer consumption of from 5 wt.-% to 25 wt.-%, preferably 10 wt.-% to 20 wt.-% of the initially employed monomers.

Monomer conversion can be tracked by online viscometry or spectroscopic monitoring during the polymerization.

In one embodiment in an optional step c), in particular where step b) was performed as a slurry process, the product medium obtained in step b) is contacted with an aqueous medium and removing at least partially the organic diluent and to the extent present in the medium removing at least partially the residual monomers and carbon dioxide to obtain an aqueous slurry comprising the polyisobutene or the butyl rubber in form of fine particles often referred to as rubber crumb. The contact can be performed in any vessel suitable for this purpose and be carried out batchwise or contiuously, whereby a continuous process is preferred. In industry such contact is typically performed in a steam-stripper, a flash drum or any other vessel known for separation of a liquid phase and vapours.

Removal of organic diluent and optionally monomers and/or residual carbon dioxide may also employ other types of distillation so to subsequently or jointly remove the residual monomers and the organic diluent and/or residuakl carbon dioxide to the desired extent. Distillation processes to separate liquids of different boiling points are well known in the art and are described in, for example, the Encyclopedia of Chemical Technology, Kirk Othmer, 4th Edition, pp. 8-311, which is incorporated herein by reference. Generally, the unreacted monomers and the diluent may either be separately or jointly be recycled into step a) of the process according to the invention.

The pressure in optional step c) and in one embodiment the steam-stripper or flash drum depends on the organic diluent and monomers employed in step b) and the content of residual carbon dioxide but is typically in the range of from 100 hPa to 5,000 hPa.

The temperature in optional step c) is selected to be sufficient to at least partially remove the organic diluent and to the extent still present residual monomers and/or carbon dioxide.

The organic diluent and/or the monomer(s) and/or residual carbon dioxide removed in step c) may be recycled into steps a) and or b) again.

In one embodiment the temperature is from 10 to 100° C., preferably from 50 to 100° C., more preferably from 60 to 95° C. and even more preferably from 75 to 95° C.

In case step b) was carried out as solution polymerization upon contact with water the organic diluent is evaporated and the polymer forms discrete particles suspended in the aqueous slurry.

In a further optional step d) the polymer contained in the aqueous slurry obtained according to step c) may be separated to obtain the polymer.

The separation may be effected by flotation, centrifugation, filtration, dewatering in a dewatering extruder or by any other means known to those skilled in the art for the separation of solids from fluids.

In a further optional step e) the copolymer particles obtained according to step d) are dried, preferably to a residual content of volatiles of 7,000 or less, preferably 5,000 or less, even more preferably 4,000 or less and in another embodiment 2,000 ppm or less, preferably 1,000 ppm or less.

As used herein the term volatiles denotes compounds having a boiling point of below 250° C., preferably 200° C. or less at standard pressure and include water as well as remaining organic diluents.

Drying can be performed using conventional means known to those in the art, which includes drying on a heated mesh conveyor belt or in an extruder.

### EXPERIMENTAL SECTION

### Examples

### A) Batch Polymerization with 11 wt % CO₂

A batch polymerization was operated at lab scale with a cooled and agitated reactor having a volume of 1.5 liter in total. The monomers isobutene (99.91%), isoprene and hexane were previously dried with molecular sieve and inhibitor remover for isoprene.

The monomers (325 g of isobutene, 6.8 g of isoprene), 200 g of hexane and 65 g solid CO₂ were mixed. The polymerization was initiated by about 5 g initiator solution. The initiator solution was prepared by using ethylaluminumsesquichloride dissolved in technical hexane and activated by traces of water. The reaction temperature was −70° C. A mixture of Ethanol with 2 wt % NaOH was used to stop the polymerization. A solution with a polymer content of 18-21 wt % was produced. The produced polymer had an average molecular weight of 370 kg/mol and an isoprene content of 1.8 mol % (measured by NMR).

### B) Batch Polymerization with 5 wt % Ethane

A batch polymerization was operated at lab scale with a cooled and agitated reactor of 1.5 litre total. The monomers isobutene (99.91%), isoprene and hexane were previously dried with molecular sieve and inhibitor remover for isoprene.

The monomers (325 g of isobutene, 6.8 g of isoprene), 234 g of hexane and 30 g liquid ethane were mixed. The polymerization was initiated by about 5 g initiator solution. The initiator solution was prepared by using ethylaluminumsesquichloride dissolved in technical hexane and activated by traces of water. The reaction temperature was −70° C. A mixture of Ethanol with 2 wt % NaOH was used to stop the polymerization. A solution with a polymer content of 17 wt % was produced. The produced polymer had an average molecular weight of 370 kg/mol and an isoprene content of 1.8 mol % (measured by NMR).

### C) Batch Polymerization with 11 wt % Ethane

A batch polymerization was operated at lab scale with a cooled and agitated reactor of 1.5 litre total. The monomers isobutene (99.91%), isoprene and hexane were previously dried with molecular sieve and inhibitor remover for isoprene.

The monomers (325 g of isobutene, 6.8 g of isoprene), 200 g of hexane and 65 g liquid ethane were mixed. The polymerization was initiated by about 5 g initiator solution. The initiator solution was prepared by using ethylaluminumsesquichloride dissolved in technical hexane and activated by traces of water. The reaction temperature was −70° C. A mixture of Ethanol with 2 wt % NaOH was used to stop the polymerization. A solution with a polymer content of 17 wt % was produced. The produced polymer had an average molecular weight of 270 kg/mol and an isoprene content of 1.8 mol % (measured by NMR).

### D) Continuous Polymerization with 6 wt % Ethane at −65° C.

A continuous polymerization was operated at pilot scale with two cooled and agitated reactors of 2 litre total capacity each running in a continuous mode. The monomers isobutene (99.91%) and isoprene were previously dried in columns filled with molecular sieve and inhibitor remover for isoprene. The water content after passing the dry columns was checked off line by Karl-Fischer titration.

The precooled feeds to the reactors were 3.87 kg/h of isobutene, 0.10 kg/h of isoprene, 1.65 kg/h of technical hexane and 0.38 kg/h liquid ethane. The polymerization was initiated by continuous feed of 15 g/h initiator solution. The initiator solution was prepared by using ethylaluminumsesquichloride dissolved in technical hexane and activated by traces of water. The reaction temperature was −65° C. A mixture of Ethanol with 2 wt % NaOH was used to stop the polymerization after the reactors. A solution with a polymer content of 15 wt % was produced. The produced polymer had an average molecular weight of 400-440 kg/mol and an isoprene content of 1.7-2.0 mol-% (measured by NMR), the gel-content was range of 0.3 wt %. The maximum overall run time was 33 h.

### E) Continuous Polymerization with 10 wt % Ethane at −65° C.

A continuous polymerization was operated at pilot scale with two cooled and agitated reactors of 2 litre total capacity each running in a continuous mode. The monomers isobutene (99.91%) and isoprene were previously dried in columns filled with molecular sieve and inhibitor remover for isoprene. The water content after passing the dry columns was checked off line by Karl-Fischer titration.

The precooled feeds to the reactors were 3.87 kg/h of isobutene, 0.10 kg/h of isoprene, 1.40 kg/h of technical hexane and 0.63 kg/h ethane. The polymerization was initiated by continuous feed of 12 g/h initiator solution. The initiator solution was prepared by using ethylaluminumsesquichloride dissolved in technical hexane and activated by traces of water. The reaction temperature was −65° C. A mixture of Ethanol with 2 wt % NaOH was used to stop the polymerization after the reactors. A solution with a polymer content of 12 wt % was produced. The produced polymer had an average molecular weight of 430 kg/mol and an isoprene content of 1.7-1.9 mol-% (measured by NMR), the gel-content was range of 0.3 wt %. The overall run time was 16 h.

What is claimed is:

1. A process for the preparation of isoolefin polymers, the process comprising at least the steps of:
a) providing a reaction medium comprising an organic diluent and at least one monomer being an isoolefin and ethane or carbon dioxide that is substantially dissolved in the reaction medium, and;
b) polymerizing the at least one monomer within the reaction medium in the presence of an initiator system to form a product medium comprising a copolymer, the organic diluent and optionally residual monomers whereby the ethane or the carbon dioxide of the reaction medium is at least partially evaporated.

2. The process according to claim 1, wherein the isoolefins are selected from those isoolefins having from 4 to 16 carbon atoms.

3. The process according to claim 1, wherein the isoolefin is isobutene.

4. The process according to claim 1, wherein the reaction medium further comprises one or more multiolefins.

5. The process according to claim 1, wherein the reaction medium further comprises isoprene.

6. The process according to claim 3, wherein the reaction medium comprises isobutene as sole monomer.

7. The process according to claim 1, wherein the organic diluent is selected from the group consisting of hydrochlorocarbon(s), hydrofluorocarbons and alkanes.

8. The process according to claim 1, wherein the boron or aluminium compounds are those represented by formula MX₃, where M is boron or aluminum and X is a halogen or those represented by formula MR₍ₘ₎X₍₃₋ₘ₎, where M is boron or aluminum, X is a halogen, R is a monovalent hydrocarbon radical selected from the group consisting of C₁-C₁₂ alkyl and C₇-C₁₄ alkylaryl radicals; and and m is one or two, whereby the term “alkylaryl” refers to a radical containing both aliphatic and aromatic structures, the radical being at an aliphatic position.

9. The process according to claim 1, wherein the boron or aluminium compounds include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride, isobutyl aluminum dichloride and diisobutyl aluminum chloride.

10. The process according to claim 1, wherein the initiators are selected from the group consisting of water, alcohols, phenols, hydrogen halides, carboxylic acids, carboxylic acid halides, carboxylic acid esters, carboxylic acid amides, sulfonic acids, sulfonic acid halides, alkyl halides, alkylaryl halides and polymeric halides.

11. The process according to claim 1, wherein the the initiator system, the monomer(s), the organic diluent ethane and/or carbon dioxide form a single phase.

12. The process according to claim 1, wherein step b) is carried out as solution process.

13. The process according to claim 1, wherein a reaction pressure in step b) from 500 to 100,000 hP.

14. The process according to claim 1, wherein steps a) and b) are carried out continuously.

15. The process according to claim 1, wherein the evaporated carbon dioxide and/or ethane is recycled into step a) or b) again.

16. The process according to claim 2, wherein the isoolefins are selected from those isoolefins having from 4 to 7 carbon atoms.

17. The process according to claim 10, wherein the initiators are selected from the group consisting of water, methanol and hydrogen chloride.

18. The process according to claim 13, wherein a reaction pressure in step b) from 1100 to 20,000 hPa.

19. The process according to claim 3, wherein the organic diluent is selected from the group consisting of hydrochlorocarbon(s), hydrofluorocarbons and alkanes;
wherein the boron or aluminium compounds include methyl aluminum dibromide, methyl aluminum dichloride, ethyl aluminum dibromide, ethyl aluminum dichloride, butyl aluminum dibromide, butyl aluminum dichloride, dimethyl aluminum bromide, dimethyl aluminum chloride, diethyl aluminum bromide, diethyl aluminum chloride, dibutyl aluminum bromide, dibutyl aluminum chloride, methyl aluminum sesquibromide, methyl aluminum sesquichloride, ethyl aluminum sesquibromide, ethyl aluminum sesquichloride, isobutyl aluminum dichloride and diisobutyl aluminum chloride; and
wherein the initiators are selected from the group consisting of water, alcohols, phenols, hydrogen halides, carboxylic acids, carboxylic acid halides, carboxylic acid esters, carboxylic acid amides, sulfonic acids, sulfonic acid halides, alkyl halides, alkylaryl halides and polymeric halides.

20. The process according to claim 19, wherein a reaction pressure in step b) from 500 to 100,000 hP.
